(19) United States
(12) Patent Application Publication
(10) Pub. No.: US 2014/0355121 A1
(43) Pub. Date: Dec. 4, 2014

(54) Ultra Broadband Multilayer Dielectric Beamsplitter Coating

(71) Applicants: Sherwyn Alan OAS, Fitchburg, WI (US); Ali MIRABEDINI, Madison, WI (US)

(72) Inventors: Sherwyn Alan OAS, Fitchburg, WI (US); Ali MIRABEDINI, Madison, WI (US)

(21) Appl. No.: 13/895,062

(22) Filed: May 15, 2013

Related U.S. Application Data
(60) Provisional application No. 61/647,301, filed on May 15, 2012.

(51) Int. Cl. G02B 27/14; G02B 1/10

(52) U.S. Cl. CPC G02B 27/142; G02B 1/10
USPC 359/583; 427/162

(57) ABSTRACT

Coatings for optical devices, such as beamsplitters, are provided. The coatings include at least one bilayer of a layer of a material having an index of refraction n₁ in contact with a layer of a material having an index of refraction n₂ and an uppermost layer of a material having an index of refraction n₃ over the bilayer, wherein n₃>n₂>n₁. The bilayer(s) can be composed of BaF₂ and KRS5. The uppermost layer can be composed of Ge. Certain coatings provide beamsplitters which exhibit highly efficient emission over broad spectral ranges.

### BACKGROUND

Multilayer dielectric coatings have been used to provide optical filters, antireflective coatings and beamsplitters for various applications such as imaging, spectroscopy and communications. The properties of the coatings required for these different devices and applications can be very different. In some applications, such as those using wavelength division multiplexing (WDM) filters, a narrow spectral performance of the filter is desirable, e.g., maximum transmission over a narrow range of wavelengths. In other applications, such as those using antireflective coatings, it is desirable to minimize reflectance to a very small amount, e.g., less than 2%, over a certain range of wavelengths.

Beamsplitters are optical devices which split a single beam of light into two separate beams, a transmitted beam and a reflected beam. A 50/50 beamsplitter transmits about 50% of the single beam of light and reflects about 50% of the single beam of light. The efficiency of a 50/50 beamsplitter is given by Equation 1.

E(Efficiency)=R(Reflectance)*T(Transmittance) Equation 1

The efficiency of an ideal 50/50 beamsplitter is 0.25. For beamsplitters used in spectroscopy, such as Fourier Transform Infrared (FTIR) Spectroscopy, a broad spectral performance may be desirable, e.g., 50% transmission (or an efficiency of 0.25) over a wide range of wavelengths. Multilayer dielectric coatings for beamsplitters have been developed, but the efficiency and spectral range of these coatings is often limited. Moreover, few, if any, multilayer dielectric coatings are able to provide highly efficient emission over a broad spectral range that encompasses the high energy portion of the spectrum, e.g., from about 1 μm to 30 μm.

### SUMMARY

Provided herein are optical coatings and optical devices using the coatings, including beamsplitters. Also provided are related methods.

Certain aspects of the invention are based, at least in part, on the inventors' findings that particular combinations, arrangements and thicknesses of certain materials can be used to form coatings that provide beamsplitters which exhibit highly efficient emission over broad spectral ranges. Moreover, these spectral ranges encompass the high energy portion of the spectrum (e.g., as high as 1 μm). The breadth of the spectral range and the extension of range to the high energy portion of the spectrum are significant at least because they provide the advantages of obtaining additional spectral information from a single beamsplitter and eliminating the need to use multiple beamsplitters to cover different spectral regions.

Accordingly, a first aspect of the present embodiments includes a coating for a beamsplitter that includes: a first bilayer of a layer of a material having an index of refraction n₁ in contact with a layer of a material having an index of refraction n₂; a second bilayer of a layer of a material having an index of refraction n₁ in contact with a layer of a material having an index of refraction n₂, the second bilayer in contact with the first bilayer; and an uppermost layer of a material having an index of refraction n₃ in contact with the first bilayer, wherein the layer of a material having an index of refraction n₁ in the first bilayer with the uppermost layer enables desired layer thicknesses of the beamsplitter that results in a spectral transmission region of up to 10000 cm⁻¹ and wherein the spectral transmission maximum is at 1000 cm⁻¹ up to 1500 cm⁻¹, and wherein, n₃>n₂>n₁.

A second aspect of the arrangements disclosed herein includes a method of constructing a beamsplitter, to include: providing a first bilayer of a layer of a material having an index of refraction n₁ in contact with a layer of a material having an index of refraction n₂; providing a second bilayer of a layer of a material having an index of refraction n₁ in contact with a layer of a material having an index of refraction n₂, the second bilayer in contact with the first bilayer; and providing an uppermost layer of a material having an index of refraction n₃ in contact with the first bilayer, wherein the layer of a material having an index of refraction n₁ in the first bilayer with the uppermost layer enables desired layer thicknesses of the beamsplitter that results in a spectral transmission region of up to 10000 cm⁻¹ and wherein the spectral transmission maximum is at 1000 cm⁻¹ up to 1500 cm⁻¹, and wherein, n₃>n₂>n₁.

Other principal features and advantages of the invention will become apparent to those skilled in the art upon review of the following drawings, the detailed description, the examples and the appended claims.

### BRIEF DESCRIPTION OF THE DRAWINGS

Illustrative embodiments of the invention will hereafter be described with reference to the accompanying drawings.

FIG. 1 depicts an example beamsplitter including an illustrative coating. The coating includes a first layer of BaF₂ over a KBr substrate, a first layer of KRS5 over the first layer of BaF₂, a second layer of BaF₂ over the first layer of KRS5, a second layer of KRS5 over the second layer of BaF₂ and an uppermost layer of Ge.

FIG. 2 depicts the simulated % transmission from a beamsplitter including the coating of FIG. 1.

FIG. 3A shows the single beam (non-ratio) spectra of a beamsplitter including the coating of FIG. 1 and a standard beamsplitter.

FIG. 3B shows an expanded view of the spectral region between about 6000 cm⁻¹ and 9000 cm⁻¹ of the spectra illustrated in FIG. 3A.

### DETAILED DESCRIPTION

Provided herein are optical coatings and optical devices using the coatings, including beamsplitters. Also provided are related methods.

### Coatings

In one aspect, a coating for an optical device, such as a beamsplitter, is provided. The coating includes a bilayer of a layer of a material having an index of refraction n₁ in contact with a layer of a material having an index of refraction n₂. By “in contact” it is meant that no intervening layer is between the layers of the bilayer. In some embodiments, the layer of the material having an index of refraction n₁ is under the layer of the material having an index of refraction n₂. In other words, in such embodiments, the layer of the material having an index of refraction n₁ is the lower layer of the bilayer and the layer of the material having an index of refraction n₂ is the upper layer of the bilayer. The coating further includes an uppermost layer of a material having an index of refraction n₃ over the bilayer. The indices of refraction of the layers in the coating are such that n₃>n₂>n₁. In some embodiments, the uppermost layer is in contact with the bilayer. In some embodiments, the uppermost layer is in contact with the layer of the material having an index of refraction n₂ in the bilayer.

In some embodiments, the coating includes two or more bilayers, each bilayer a layer of a material having an index of refraction n₁ in contact with a layer of a material having an index of refraction n₂, and an uppermost layer of a material having an index of refraction n₃ over the two or more bilayers. The indices of refraction of the layers in the coating are such that n₃>n₂>n₁. In some embodiments, the coating includes two bilayers, three bilayers, or more. In some embodiments, the two or more bilayers form a stack of bilayers in which each bilayer is in contact with an adjacent bilayer, without intervening layers between adjacent bilayers. As noted above, the layers of the bilayers may be arranged such that the layer of the material having an index of refraction n₁ is under the layer of the material having an index of refraction n₂. Similarly, the uppermost layer may be in contact with a bilayer and the uppermost layer may be in contact with the layer of the material having an index of refraction n₂ within the bilayer.

In other embodiments, the coating consists essentially of, or consists of, a stack of one, two, or three bilayers, each bilayer a layer of a material having an index of refraction n₁ in contact with a layer of a material having an index of refraction n₂, and an uppermost layer of a material having an index of refraction n₃ over the stack. The indices of refraction of the layers in the coating are also such that n₃>n₂>n₁. As noted above, the layers of the bilayers may be arranged such that the layer of the material having an index of refraction n₁ is under the layer of the material having an index of refraction n₂. Similarly, the uppermost layer may be in contact with a bilayer and the uppermost layer may be in contact with the layer of the material having an index of refraction n₂ within the bilayer

The materials for the layers of the bilayer and the uppermost layer may vary. A variety of dielectric materials may be used for the layers of the bilayers. In some embodiments, the material having an index of refraction n₁ is KBr, BaF₂, PbF₂, or Na₃AlF₆. In some embodiments, the material having an index of refraction n₂ is Thallium Bromo-Iodide (also known as KRS5 or TlBr—TlI) or ZnSe. In some embodiments, the material having an index of refraction n₃ is Ge.

The coating may be further characterized by specifying certain materials that are not included in certain layers of the coating. In some embodiments, the layers of the bilayer(s) do not include Ge. In other embodiments, the layers of the bilayer(s) and/or the uppermost layer do not include a metal oxide, e.g., silica, a carbide or a nitride. In still other embodiments, the layers of the bilayer(s) and/or the uppermost layer do not include a polymer or a substituted or unsubstituted organic molecule. In each of these embodiments, it is meant that the coating or layers of the coating do not intentionally include these materials. One or more of these materials may be present in the coating at a level (e.g., as an impurity) that is typical for standard techniques for forming optical coatings.

In some embodiments, the materials for the coating are selected such that the bilayer(s) are composed of a layer of BaF₂ and a layer of KRS5. This particular combination provides surprisingly beneficial results as the inventors have found that this is a particularly good combination of materials for the disclosed optical devices. Specifically, the inventors have found that the inter-diffusion and/or chemical interaction of BaF₂ and KRS5 is minimal or nonexistent during the deposition process. Thus, during the deposition process itself, because the inter-diffusion and/or chemical interaction of BaF₂ with the Ge (which is often a weather resistant coating) is surprisingly minimal or nonexistent there is no degradation of the Reflectance/Transmittance (R/T) properties of the final coating/substrate combination because the designed thicknesses of such layers are maintained with a degree of precision.

In addition, for those embodiments in which the uppermost layer is in contact with the layer of KRS5 within a bilayer, the KRS5 inhibits or prevents the diffusion of BaF₂ and/or its constituents into the uppermost layer, thereby maintaining the index of refraction and integrity of the uppermost layer. In some embodiments, the materials for the coating are selected such that the bilayer(s) are composed of a layer of BaF₂ and a layer of KRS5 and the uppermost layer is composed of Ge.

The thicknesses of each of the layers in the coatings may vary. In some embodiments, the thickness of the layer of the material having an index of refraction n₁ is in the range from about 800 Å to 1500 Å and the thickness of the layer of material having an index of refraction n₂ is in the range from about 500 Å to 2800 Å. In other embodiments in which the coating includes a first bilayer, a second bilayer and an uppermost layer in contact with the first bilayer, the thicknesses may vary as follows. The thickness of the layer of the material having an index of refraction n₁ in the first bilayer is in the range from about 1250 Å to 1500 Å; the thickness of the layer of the material having an index of refraction n₂ in the first bilayer is in the range from about 2550 Å to 2800 Å; the thickness of the layer of the material having an index of refraction n₁ in the second bilayer is in the range from about 800 Å to 1000 Å; and the thickness of the layer of the material having an index of refraction n₂ in the second bilayer is in the range from about 500 Å to 700 Å. In some embodiments, the thickness of the layer of the material having an index of refraction n₃ is in the range from 1250 Å to 1500 Å.

The coatings may be further characterized by the optical properties they provide. In some embodiments, the coating is characterized in that it provides a beamsplitter when coated over a substrate. In some embodiments, the coating is characterized in that it provides a beamsplitter including the coating with a transmission of about 50% at about 2 μm. In some embodiments, the coating is characterized in that it provides a beamsplitter including the coating with a transmission percentage of about 50%+/−5% over the spectral range from about 1000 cm⁻¹ to about 10000 cm⁻¹ (i.e., about 9.5 μm down to about 1. μm) with a high transmission percentage of up to 90% at about the 9000 cm⁻¹ (˜1.1 μm) energy range. The coatings may be distinguished from antireflective coatings and coatings for optical filters. Thus, in some embodiments, the coating is characterized in that it does not provide an antireflective coating and/or an optical filter when coated onto a substrate.

### Optical Devices

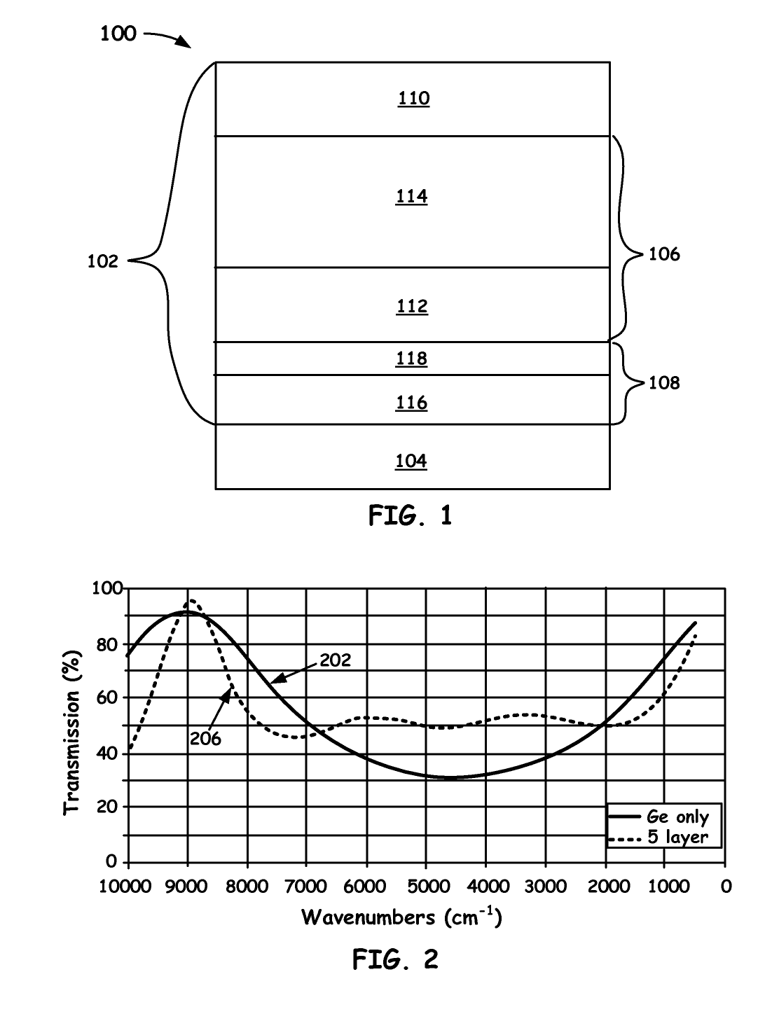

In another aspect, optical devices including the disclosed coatings are provided. The optical devices include a substrate and any of the coatings disclosed above coated over the substrate. In some embodiments, the optical device consists essentially of, or consists of, the substrate and any one of the disclosed coatings coated over the substrate. As example beneficial substrate materials to be utilized herein, the substrate can be selected from KBr, Silicon, Quartz, Calcium Fluoride, and Zinc Selenide. In some embodiments, the layer of the material having an index of refraction n₁ of a bilayer is in contact with the substrate. In some embodiments, the optical device is a beamsplitter. An illustrative beamsplitter 100 is shown in FIG. 1. The beamsplitter includes a substrate 104 and a coating 102. The coating 102 includes a first bilayer 106, a second bilayer 108 and an uppermost layer 110 (i.e., fifth layer) over the bilayers. The first bilayer 106 includes an example third layer 112 of a material having an index of refraction n₁ under a fourth layer 114 of a material having an index of refraction n₂. The second bilayer 108 of FIG. 1 is shown to often include a first layer 116 of a material having an index of refraction n₁ under a second layer 118 of a material having an index of refraction n₂. In some embodiments, the optical device is not an antireflective optical device and/or an optical filter.

The optical devices may be used in a variety of spectroscopic applications, such as Fourier Transform Infrared (FTIR) Spectroscopy. Thus, also provided are FTIR instruments including any of the disclosed optical devices.

### Methods

Also provided are methods of forming the coatings and optical devices. The methods involve sequential deposition of the layers of any of the disclosed coatings. Standard techniques and deposition parameters may be used for depositing layers of dielectric material, including electron beam evaporation, thermal evaporation, sputtering, chemical vapor deposition and plasma enhanced chemical vapor deposition. By way of example only, a beamsplitter may be formed by depositing a layer of a material having an index of refraction n₁ on a substrate, depositing a layer of a material having an index of refraction n₂ over the layer of the material having an index of refraction n₁ to form a lower bilayer; depositing a layer of a material having an index of refraction n₁ on the lower bilayer, depositing a layer of a material having an index of refraction n₂ on the layer of the material having an index of refraction n₁ to form an upper bilayer; and depositing an uppermost layer of a material having an index of refraction n₃ on the upper bilayer. Additional details of this embodiment of the method are provided in the Examples, below.

Also provided are methods of using any of the disclosed optical devices. In some embodiments, the optical device is a beamsplitter and the methods include splitting a light beam into a transmitted beam and a reflected beam with the beamsplitter. The methods can further include directing a light beam at the beampslitter.

The coatings, optical devices and related methods will be understood more readily by reference to the following example, which is provided by way of illustration and is not intended to be limiting.

### Example

In particular, the reader is directed again to the example configuration of the beamsplitter 100 arrangement shown in FIG. 1. Specifically, the preferred design is configured In Table 1 as follows:

TABLE 1
A KBr Substrate (Ref. Character 104)

| | | | | | |
|---|---|---|---|---|---|
| 1^{st} layer | BaF2 | 900 Angstroms | (Ref. Character 116) | | |
| | | | | {close oversize bracket} | -Bilayer 2 |
| 2^{nd} layer | KRS5 | 590 Angstroms | (Ref. Character 118) | | |
| 3^{rd} layer | BaF2 | 1380 Angstroms | (Ref. Character 112) | | |
| | | | | {close oversize bracket} | -Bilayer 1 |
| 4^{th} layer | KRS5 | 2600 Angstroms | (Ref. Character 114) | | |
| 5^{th} layer | Ge | 1380 Angstroms | (Ref. Character 110) | | -Upper Layer |

FIG. 2 shows the theoretical transmission properties of a single layer Ge coating 202 (about 1388 Angstroms (denoted as a solid line)) and a novel 5 layer 206 design (denoted as a dashed line) of the present application having the recipe of Table 1, as shown above. The theoretical calculations assume the material layers have well defined boundaries (no diffusion layer) and the index of refraction of the materials maintains known measured values.

Specifically, FIG. 2 shows that a designed 5 layer beamsplitter 206 configuration results in a beneficial transmission percentage of about 50%+/−10% to provide a broader range of efficiency across the spectral range from about 1000 cm⁻¹ to about 10000 cm⁻¹ (i.e., about 9.5 μm down to about 1. μm) with a noted notch high transmission (˜90%) at about the 9000 cm⁻¹ (˜1.1 μm) energy range. It is also to be appreciated that FIG. 2 shows some information about the Reflection*Transmission product value of the coatings. In particular, at 1000 cm⁻¹ it is clear that the 5 layer coating 206 has a value of 60% T. By contrast, the Ge coating 202 has a value of 75% T. Accordingly, the 5 layer 206 R*T product=0.4*0.6=0.24 wherein the Ge 202 coating R*T product=0.75*0.25=0.188. This makes the 5 layer coating 28% better than the Ge coating (0.24/0.188=1.28). This translates into 28% more signal (i.e., increased efficiency) when used as a beamsplitter in a desired spectrometer for a desired application.

It is to be appreciated that the design parameters of the example optical device beamsplitter shown above was with the aid of TFCalc (Thin Film Design Software) from: Software Spectra, Inc., 14025 N.W. Harvest Lane, Portland, Oreg. 97229, although any thin film design software capable of aiding in the construction of the present embodiments may also be used when desired.

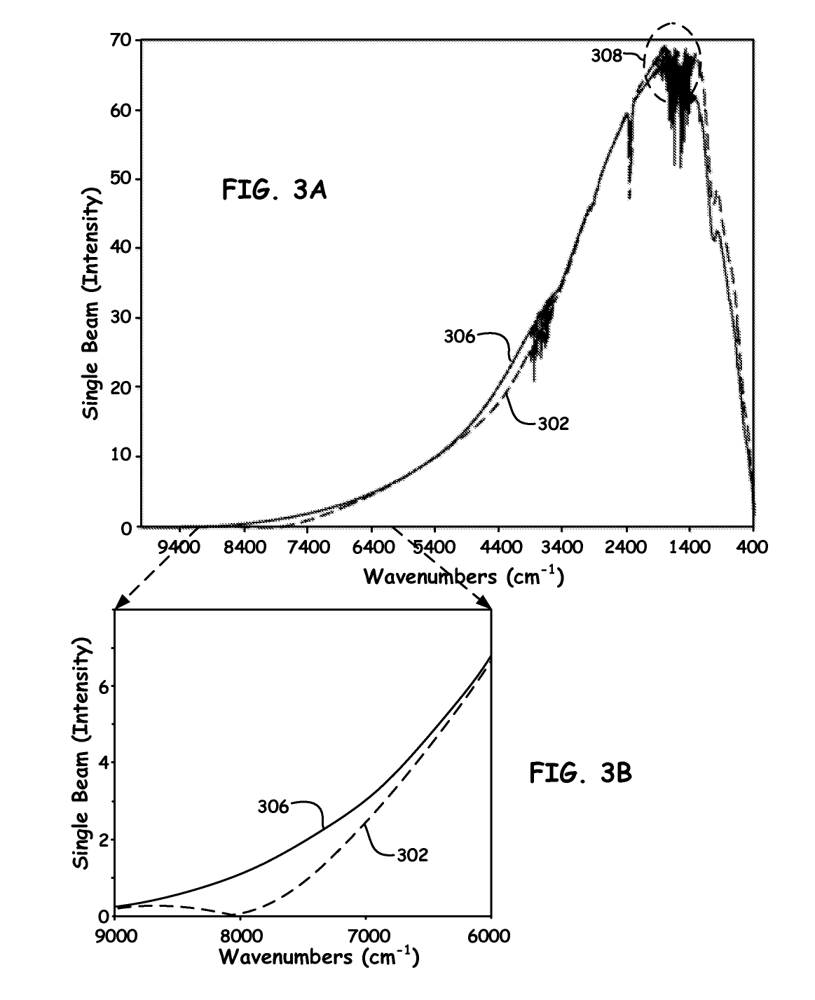

To further appreciate the novel aspects of the embodiments herein, the reader is directed to FIG. 3A, which illustrates a single beam (non-ratio) intensity spectra comparison between a beamsplitter coating of a known design 302 (a 2 layer design as denoted by a dashed line) and a 5-layer design 306 (denoted as a solid line). FIG. 3B shows an expanded view of the spectral region between 6000 cm⁻¹ and 9000 cm-1 illustrating beneficially the extended transmission performance beyond 9000 of the present example application. In particular, using the novel beamsplitter recipe shown above, it is to appreciated when specifically reviewing FIG. 3B that at the high energy end, i.e., beyond 7000 cm⁻¹, the energy throughput of the known formulation 302 (again note dashed line) rapidly drops to zero starting around 6000 cm⁻¹ while the 5-layer structure 306 disclosed herein continues to transmit energy up to 8000 cm⁻¹ and beyond (e.g., up to at least 10000 cm⁻¹), resulting in a significantly expanded spectral range for measurement.

In addition, it is to be noted that a surprising additional aspect of the 5 layer design 306 is that the configuration also leaves intact (i.e., substantially non-shifted in spectral location) the location of a maximum spectral transmission 308 (˜1000 cm⁻¹-1500 cm⁻¹) region, which is desirably situated over the infrared fingerprint region with no loss of energy, as generally shown in the dashed elliptical region of FIG. 3A. This is an important aspect because previous designs that have provided for an expanded spectral coverage into the high energy region(s) suffer from a significant shift in the maximum transmission away from the fingerprint region as well as a drop in throughput. This combination is the novelty provided herein.

The word “illustrative” or “exemplary” is used herein to mean serving as an example, instance, or illustration. Any aspect or design described herein as “illustrative” or “exemplary” is not necessarily to be construed as preferred or advantageous over other aspects or designs. Further, for the purposes of this disclosure and unless otherwise specified, “a” or “an” means “one or more.” Still further, the use of “and” or “or” is intended to include “and/or” unless specifically indicated otherwise.

All patents, applications, references, and publications cited herein are incorporated by reference in their entirety to the same extent as if they were individually incorporated by reference.

As will be understood by one skilled in the art, for any and all purposes, particularly in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than,” and the like includes the number recited and refers to ranges which can be subsequently broken down into sub-ranges as discussed above. Finally, as will be understood by one skilled in the art, a range includes each individual member.

The foregoing description of illustrative embodiments of the invention have been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A coating for a beamsplitter, comprising:
a first bilayer of a layer of a material having an index of refraction n₁ in contact with a layer of a material having an index of refraction n₂;
a second bilayer of a layer of a material having an index of refraction n₁ in contact with a layer of a material having an index of refraction n₂, the second bilayer in contact with the first bilayer;
a substrate coupled to said second bilayer; and
an uppermost layer of a material having an index of refraction n₃ in contact with said first bilayer, wherein said first and second bilayers of selected materials configured with said uppermost layer material are configured with designed layer thicknesses to provide a beamsplitter coating with a spectral transmission region of up to 10000 cm⁻¹, wherein the spectral transmission maximum is at 1000 cm⁻¹ up to 1500 cm⁻¹, and wherein, n₃>n₂>n₁.

2. The coating of claim 1, wherein said material having an index of refraction n₁ configured in said first bilayer or said second bilayer is at least one of the following materials selected from: KBr, BaF₂, PbF₂, and Na₃AlF₆.

3. The coating of claim 1, wherein said material having an index of refraction n₂ configured in said first bilayer or said second bilayer is at least one of the following materials selected from: Thallium Bromo-Iodide (KRS5) and ZnSe.

4. The coating of claim 1, wherein said uppermost layer of said material having an index of refraction n₃ comprises Ge.

5. The coating of claim 1, wherein the thickness of the layer of said material having an index of refraction n₁ in said first bilayer is in the range from about 1250 Å up to about 1500 and the thickness of the layer of said material having an index of refraction n₂ in said first bilayer is in the range from about 2550 Å up to about 2800 Å; and wherein the thickness of the layer of said material having an index of refraction n₁ in said second bilayer is in the range from about 800 Å up to about 1000 Å and the thickness of the layer of said material having an index of refraction n₂ in said second bilayer is in the range from about 500 Å up to about 700 Å, and wherein the thickness of said uppermost layer having an index of refraction n₃ is in the range from 1250 Å up to about 1500 Å.

6. The coating of claim 5, wherein said beamsplitter coating thicknesses and selected materials provide a transmission percentage of about 50%+/−5% over the spectral range from about 1000 cm⁻¹ to about 10000 cm⁻¹ with a high transmission percentage of up to 90% at about the 9000 cm⁻¹.

7. A method of constructing a beamsplitter, comprising:
providing a first bilayer of a layer of a material having an index of refraction n₁ in contact with a layer of a material having an index of refraction n₂;
providing a second bilayer of a layer of a material having an index of refraction n₁ in contact with a layer of a material having an index of refraction n₂, the second bilayer in contact with the first bilayer;
providing a substrate to be coupled to said second bilayer; and
providing an uppermost layer of a material having an index of refraction n₃ in contact with the first bilayer, wherein said provided first and second bilayers of selected materials configured with the uppermost layer material are designed with layer thicknesses to provide a beamsplitter coating with a spectral transmission region of up to 10000 cm⁻¹, wherein the spectral transmission maximum is at 1000 cm⁻¹ up to 1500 cm⁻¹, and wherein, n₃>n₂>n₁.
